(19) United States
(12) Patent Application Publication
(10) Pub. No.: US 2015/0227866 A1
(43) Pub. Date: Aug. 13, 2015

(54) COLLABORATIVE FORECAST SYSTEM AND METHOD

(71) Applicant: VISEO ASIA PTE. LTD., Singapore (SG)

(72) Inventors: Nicolas COMMARE, TASSIN LA DEMI-LUNE (FR); Mehdi KHARAB, PARIS (FR); Thibault PARMENTIER, MEYLAN (FR)

(73) Assignee: VISEO ASIA PTE. LTD., Singapore (SG)

(21) Appl. No.: 14/175,727

(22) Filed: Feb. 7, 2014

(51) Int. Cl. G06Q 10/06

(52) U.S. Cl. CPC G06Q 10/0631

(57) ABSTRACT

A computerized system is described. The system has a set of client terminals for respective users, an enterprise resource planning server, a collaboration server, means for receiving from a plurality of client terminals and for storing a plurality of forecast data values, means for setting rules relating to said values, means for detecting lack of compliance between said values and said rules, and a collaborative consensus engine for launching a collaborative consensus session accessible by client terminals corresponding to users involved in the lack of compliance.

### TECHNICAL FIELD

The present disclosure relates to planning and scheduling systems and methods and more specifically to collaborative planning methods.

### BACKGROUND

Advanced planning and scheduling software solutions (APS) are intended to ensure that the supply chain organizational model (material and information flow from the supplier to the distributor over manufacturing) matches a much more uncertain reality. These solutions address with optimization mathematical methods complex planning problems that are inadequately covered by enterprise resource planning management systems (ERP). These APS are used to define sales forecasts.

First of all, Cachon and Fisher state that sharing of downstream sales data is likely to have a significantly greater value in situations of unknown demand, such as new product introductions or promotions. On the other hand, Lee et al. (1997b) and Barrattand Oliveira (2001) argue that although sharing of downstream sales data is beneficial, it does not provide sufficient visibility of demand.

Based upon a review of existing literature and a survey of participants in existing CPFR (Collaborative Planning, Forecasting and Replenishment) implementations, Barratt and Oliveira (2001) have identified inhibitors of CPFR. Their survey identifies lack of discipline to properly execute the preparatory phases of the CPFR process model, lack of joint planning, difficulties in managing the exceptions and review processes related to sales and order forecasting, and lack of shared targets as significant inhibitors.

Time series methods that build on historical data can forecast changes that follow continuous or recurring patterns, but cannot accurately forecast the impact of events, such as price changes, that happen irregularly (Bowersox and Closs, 1996, p. 233; Mentzer and Schroeter, 1994).

Overall, much of the frustration experienced with APS is due to a misconception and incompetent utilization of APS. Often companies have not been aware that APS require different skills compared to Enterprise Resource Planning, especially in complex decision situations in which many alternative activities have to be combined in order to construct a feasible, high quality plan for supply chain APS (Bernhard Fleischmann and al., Advanced Planning in Supply Chains. Springer, 2011).

Different solutions have been proposed in order to try to solve these problems.

For example, the editor TXT eSolution® proposes in APS TXT Planning® a method consisting in segmenting an initial forecast at the N-level into initial sub-forecasts at the N−1 level, the weighted sum or aggregation of which corresponds to the initial N-level forecast. The disaggregation can then be performed at the N−2 levels to 1 according to a tree that can have the desired detail of ramification.

Second, a N−m level collaborator, involved in the planning process, may be authorized to modify the N−m initial sub-forecast to develop his own sub-forecast, which will have an impact on the N−m+1 level aggregate forecast and will spread to the N-level according a path up a level in this tree. Thus, this change at N−m level will result into conflicts between the initial i-level forecasts and the i-level aggregate forecasts, whereby “i” takes the values N−m+1 to N.

This known data processing tool thus enables each collaborator associated with this path to visualize the related conflict(s) and to negotiate with his collaborators of the immediately lower or higher level in this tree to reach a resolution to this conflict(s).

Moreover, it is possible to define a forecast according to several axes, for example, a geographical axis (for instance “world—United States—Texas—Houston”), a product axis (for instance “all products—furniture—desk—chairs”), a trademark and distribution network axis, etc. Thus, a new tree-structure corresponds to each axis. The conflicts are managed in the same way according to all axes.

This method thus has the advantage of involving many collaborators in the planning process. On the other hand, any N−m level change results in m conflicts, i.e. a number of transactions to try to solve these conflicts. But the result of these transactions impacts the other axes, which in practice generates back and forth effects in the trees or forecasts that oscillate and do not allow convergence to coherent planning.

The tool known as N.Skep®, edited by Dynasys, proposes to predefine a limited set of intersections of axes in order to reduce the number of conflicts. The intersection “Furnishing in Houston” will, for example, be part of this set, while “Chairs in Texas” will not be part thereof. Furthermore, two collaborators will not be allowed to simultaneously modify the forecast of an intersection, except for segmenting it into two disjoint perimeters, for example “Chairs with armrests” and “Chairs without armrests”, each perimeter being assigned to a specific collaborator.

Similarly, SAP® proposes APO® in which the changes of intersection forecasts may not be made simultaneously by several collaborators.

Thus, these solutions have at least one of the following disadvantages:
too many back and forth actions to try to manage the conflicts,
divergences of the forecasts,
lack of sustainability of the forecasts. Since they are performed in silos, i.e. without intersections between collaborators, they are not the result of a stabilized consensus.

### SUMMARY

It has been observed:
that a modification performed at a lower level in the tree could be substantial at this level without having any substantial impact at a higher level; therefore, introducing a principle of tolerance at this higher level would make possible to limit the number of conflicts;
that the divergences between the forecasts could be gradually circumscribed by performing a step-by-step determination of certain data of these forecasts;
that conflicts due to exceeding tolerance thresholds could also be circumscribed by means of a progressive locking of certain data of these forecasts; and
that the implementation of control panels shared by a plurality of collaborators involved in the same conflict would facilitate the resolution thereof.

Therefore, the present disclosure proposes a system and method for the simultaneous collaborative development of forecasts that enables to reduce the number of conflicts and to facilitate the resolution thereof.

To this end, the present disclosure provides according to a first aspect, a computerized system comprising:
a set of client terminals for respective users,
an enterprise resource planning server accessible by said client terminals and storing business data, including business historical data,
a collaboration server in communications with said enterprise resource planning server and also accessible by said client terminals,
means for receiving from a plurality of client terminals controlled by a plurality of hierarchically-organized users and for storing a plurality of forecast data values including main forecast values and sub-forecast values and elementary data values as subdivisions of said forecast values and said sub-forecast values,
means for setting rules relating to said values, said rules including aggregation rules for said values and alert thresholds for said values,
means for detecting lacks of compliance between said values and said rules, and
a collaborative consensus engine for launching a collaborative consensus session accessible by client terminals corresponding to at least a group of users having provided values involved in the lack of compliance, said engine being adapted for selectively displaying alert indications in response to said detection means, values involved in said lack of compliance, for changing values in response to actions by users entitled to make value changes so as to remove lack of compliance, for computing other values in response to the change of values, for setting and changing rules in response to actions by users entitled to make rule changes, and for causing said detection means to detect again lacks of compliance after changes performed through said collaborative consensus engine.

Preferred but non-limiting aspects of this system include the following features, taken individually or in any technically compatible combination:
The system further comprises means for generating an initialization set for said values, said initialization set comprising initial values determined from historical data, access and modification rights for each user for said values, hierarchical data structures for said values, and said aggregation rules.
The system further comprises means for generating original values from said initial values in response to inputs by users entitled to change said values.
Said means for setting rules comprise user interface means for setting a lower limit value or an upper limit value or a tolerance range for a forecast value, and said detection means comprise means for detecting when a sub-forecast value belonging to an aggregation leading to said forecast value has caused a breaking of the limit value or range.
Said means for setting rules comprise user interface means for freezing a forecast value, and said detection means comprise means for detecting when a sub-forecast value belonging to an aggregation leading to said forecast value has caused a violation of the frozen value.
Said means for setting rules comprise user interface means for freezing a forecast value, and the collaborative consensus engine is capable of computing values of sub-forecast values aggregated into said forecast value based on the frozen value.
Said collaborative consensus engine comprises means for displaying the relative weights of value changes in a given lack of compliance.
Said hierarchical data structures comprise data tree-structures along at least two axes, and said collaborative consensus engine comprises means for forcing an aggregated forecast value along one axis to equal an aggregated forecast value along another axis and for re-computing sub-forecast values along said two axes in accordance with said forcing.

According to a second aspect, the present disclosure provides a computed-implemented collaborative forecasting method implemented in a computerized environment including a set of client terminals for respective users, an enterprise resource planning server accessible by said client terminals and storing business data, including business historical data, and a collaboration server in communications with said enterprise resource planning server and also accessible by said client terminals, said method comprising the following steps:
receiving at said collaboration server from a plurality of client terminals controlled by a plurality of hierarchically-organized users a plurality of forecast data values including main forecast values and sub-forecast values and elementary data values as subdivisions of said forecast values and said sub-forecast values, and storing said values,
detecting lack of compliance between said values and predefined rules relating to said values, said rules including aggregation rules for said values and alert thresholds for said values,
in a collaborative consensus user interface, selectively displaying values involved in said lack of compliance, performing at least one of the following consensus-reaching steps:
   changing values in response to actions by users entitled to make value changes so as to remove lack of compliance,
   in response to a value change, re-computing values linked to said changed value through aggregation rules,
   setting and changing rules in response to actions by users entitled to make rule changes,
      and
detecting again said a lack of compliance after at least one consensus-reaching step has been performed.

Preferred but non-limiting aspects of this method include the following features, taken individually or in any technically compatible combination:
The method further comprises a step of generating an initialization set for said values, said initialization set comprising initial values determined from historical data, access and modification rights for each user for said values, hierarchical data structures for said values, and said aggregation rules.
The method further comprises a step of generating original values from said initial values in response to inputs by users entitled to change said values.
Said step of setting rules comprises setting a lower limit value or an upper limit value or a tolerance range for a forecast value, and said detection step comprises detecting when a sub-forecast value belonging to an aggregation leading to said forecast value has caused a breaking of the limit value or range.
Said step of setting rules comprises freezing a forecast value, and said detection step comprises detecting when a sub-forecast value belonging to an aggregation leading to said forecast value has caused a violation of the frozen value.
Said step of setting rules comprises freezing a forecast value, and further comprising a step of computing values of sub-forecast values aggregated into said forecast value based on the frozen value.
The method further comprises a step of displaying the relative weights of value changes in a given lack of compliance.
Said hierarchical data structures comprise data tree-structures along at least two axes, and the method further comprises a step of forcing an aggregated forecast value along one axis to equal an aggregated forecast value along another axis and a step of re-computing sub-forecast values along said two axes in accordance with said forcing.

### BRIEF DESCRIPTION OF THE DRAWINGS

Other aims, features and advantages of the present disclosure will be better understood from the following description of preferred embodiments thereof, given by way of non-limiting example and with reference to the appended drawings, in which:

FIG. 1 is an overview of a system architecture for implementing the present disclosure.

FIG. 2A shows a graph and a table containing forecast data and parameters used as an example for the purpose of the present disclosure.

FIG. 2B illustrates a display generated by a collaboration server for leading users to a forecast consensus.

FIG. 3 illustrates another display generated by the collaboration server for collaboratively imposing different types of constraints on a forecast curve.

FIG. 4 is a flow chart of a method implemented in the collaboration server according to the present disclosure.

### DETAILED DESCRIPTION

### a) System

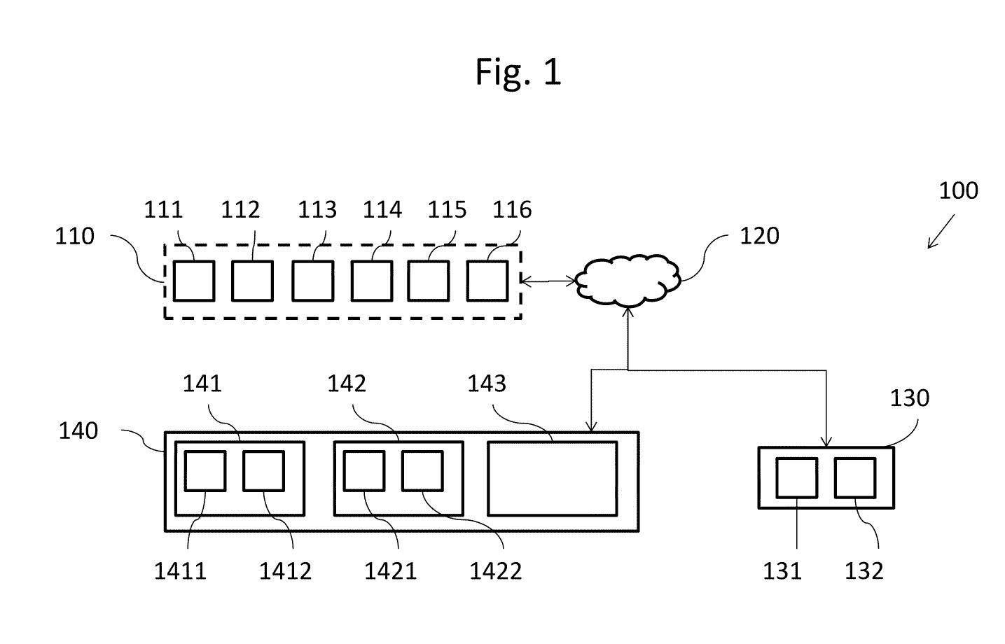

Referring to FIG. 1, a data processing system 100 comprises a set 110 of users 111, 112, 113, 114 respectively equipped with client terminal (such as a personal computer) and connected by a network 120 (such as the Internet) to an ERP server 130 and to a collaboration server 140, preferably implemented by an ASP server.

The ERP server 130 is a data processing system comprising an Enterprise Resource Planning (ERP) manager 131 and a database 132 of historical data.

The ASP server 140 is a data processing system comprising a historical analysis module 141 comprising an analysis engine 1411 and a model 1412. The analysis engine 1411 comprises software capable of analyzing the historical database 132 of the ERP 131 in order to extract therefrom:
(i) values (turnover, number of sales, number of items, logistic chain flow etc.),
(ii) access and modification rights for each user for these values,
(iii) consolidation tree-structures for these values according to a plurality of axes or dimensions (by geography, by product, by distributor etc.) and
(iv) an aggregation method for these values for each node of each tree-structure, and in particular a relative weight value stored for every branch connected to a single node.

The analysis engine 1411 associates the values, the rights, the tree-structures and the aggregation method for developing a model 1412. This method is known per se to the skilled person. It consists, for example in the known TXT Planning® tool, in parameterizing an interface with the ERP of the enterprise.

The ASP server 140 also comprises an initialization module 142 that includes a transposition editor 1421 and an initialization set 1422. The transposition editor 1421 is capable of converting a model 1412 into an initialization set 1422. To this end, the transposition editor 1421 authorizes a specific user such as 111, for example a sales director, to parameterize this transposition.

This transposition consists, for example, in copying the sales history of the last 12 months and adding a set increase trend, e.g. +5%, thereto in order to obtain a forecast for the next 12 months. In this example, the parameters for the transposition include a starting date and an end date that define a range of historical values, in this case the last 12 months, and a trend, in this case +5%. This transposition is known to the skilled person and available for instance in the TXT Planning® tool as a forecast computation means.

In order to improve such transposition, the transposition parameters may further include a cyclicality, for example 4 years in the case of businesses related to Olympic Games, a seasonality in the case of Christmas time, a cap, for example production capacity cap, a lower bound, for example a delisting threshold, a weighting impacting the aggregation method, a smoothing that enables to detect and to reduce peaks in the historical curves.

These transposition parameters can be applied to all tree-structure levels and to all axes. The initialization set 1422 is thus composed of a structured set of rights, of tree structures, of an aggregation method and of initial values 14224.

The ASP server 140 also comprises an edition module 143 that enables a user such as 112 to visualize and to modify the initial values of the initialization set 1422 by virtue of the edition rights, also contained in the initialization set, which said user enjoys. For example, a sales manager such as 112, responsible for the worldwide sales of furniture, will have the rights to modify the sales forecasts related to the corresponding scope of business. The edition module 143 also enables the users such as 112, 113-114 to develop collaborative forecasts, as described hereinafter.

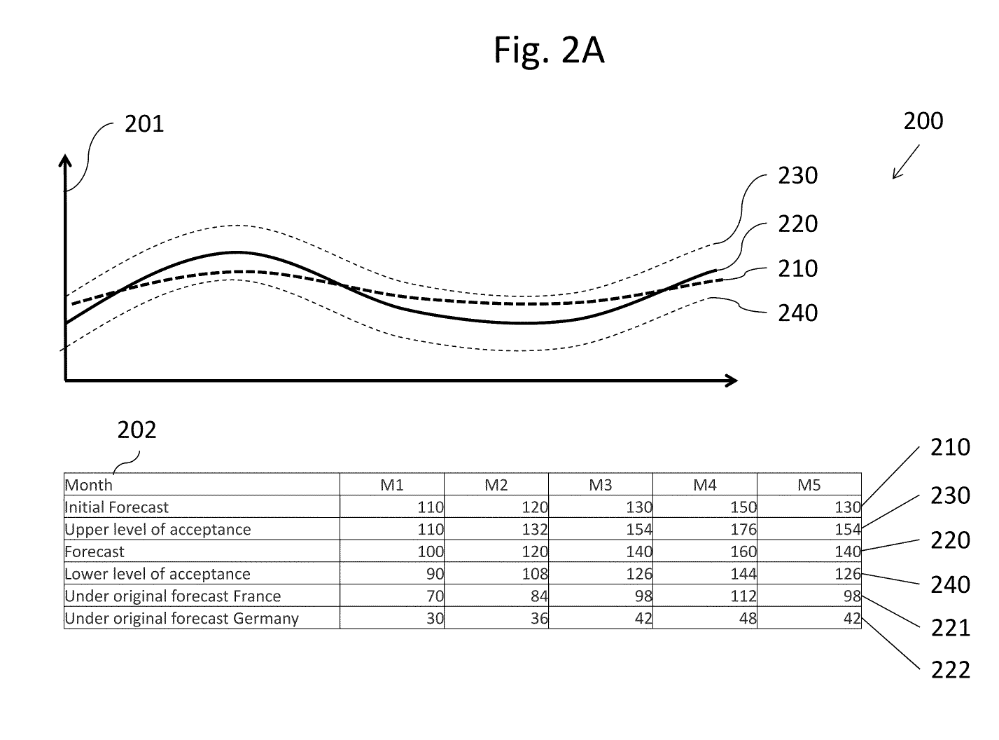

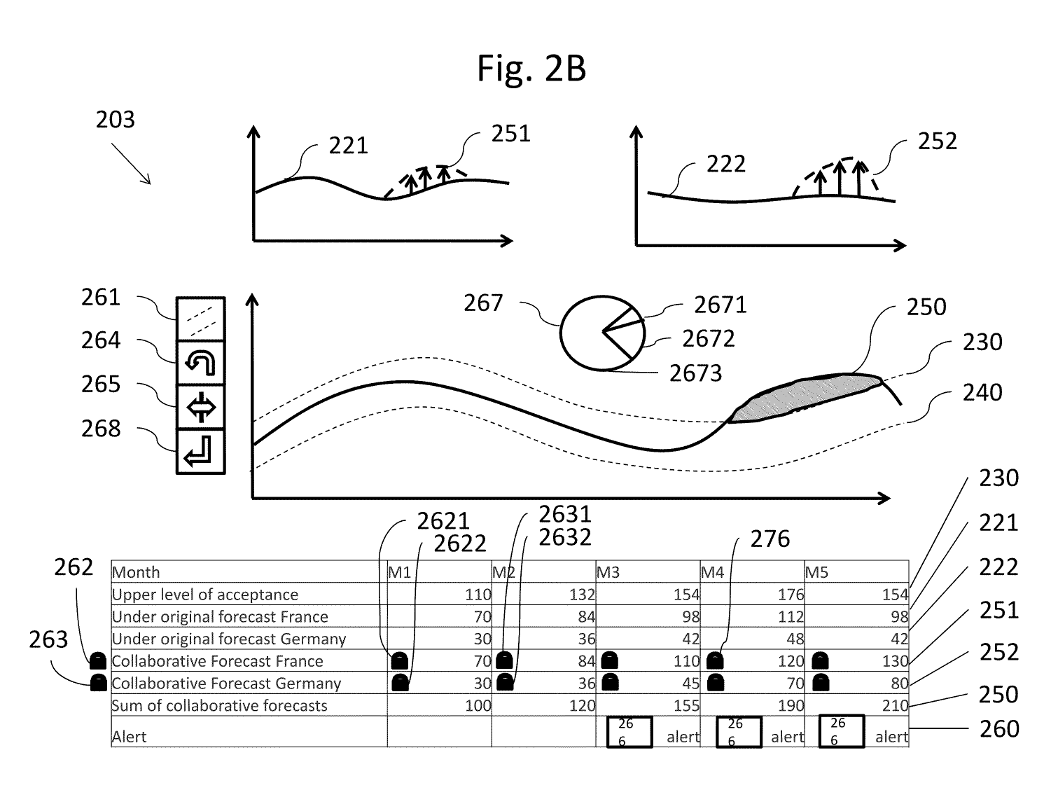

Referring now to FIG. 2A, activity forecasts 200, such as monthly turnover related to a given user 112, consist in a plurality of sets of elementary data values, generated by the edition module 143 for the display on his client terminal as a graph 201 and a table 202. A first set of data, extracted from the initial values of the initialization set 1422, forms an initial forecast 210 and initial sub-forecasts (not shown). The elementary data are subdivisions (time subdivisions or other subdivisions) of these forecasts and sub-forecasts.

The initial forecast 210 corresponds e.g. to the worldwide sales of furniture. The initial sub-forecasts are sets of data with a lower level than the initial forecast 210 in the tree-structure of the initialization set 1422. In this embodiment, the initial sub-forecasts correspond respectively to the sales of furniture e.g. in France and in Germany. According the aggregation method contained in the initialization set 1422, these data, that are consolidated month by month, constitute the data of the initial forecast 210 at the worldwide level.

This initial forecast 210 can be modified by user 112, for instance graphically by a drag-and-drop operation on a point of the curve or by direct value entry in the table, like in a spreadsheet. The so-modified initial forecast 210 forms an original forecast 220. It is associated with a tolerance corridor or range, for example of more or less 10%, resulting into two other sets of data computed from the original forecast 220, i.e. and upper tolerance boundary or limit 230 and a lower tolerance boundary or limit 240.

The validation by the user 112 of the original forecast 220 causes the generation of two original sub-forecasts 221, 222. These sub-forecasts are computed respectively data per data on the base of two initial sub-forecasts 211, 212, according to the following pro rata rule:

$$original sub \text{-} forecast i = \frac{initial sub \text{-} forecast i \times original forecast 220}{initial forecast 210}$$

Referring to the bottom of FIG. 2B, using the edition module 143 and of the modification rights contained in the initialization set 1422, the original sub-forecasts 221, 222 can be modified, in this example respectively by the furniture sales manager 113 in France and the furniture sales manager 114 in Germany, so as to form collaborative forecasts 251, 252. The consolidation thereof, i.e. the addition of their respective data month for month, forms the collaborative forecast 250 at the level of the furniture worldwide sales manager 112.

When this collaborative forecast lacks compliance with certain rules governing the forecasts, e.g. when collaborative forecast 250 exceeds the tolerance range 230, 240, a lack-of-compliance or conflict alert 260 is generated by the edition module 143 and communicated to the relevant users (in this case users 112, 113, 114).

A conflict alert 260 comprises an indication of the out-of-range forecast as well as additional information. This information is accessible by menus adapted to inform the user about:
the nature of the conflict, for example “Out-of-Tolerance Range conflict”, “Divergence conflict”, etc.,
the business level of the conflict, for example the “Furniture Worldwide Sales”,
the name and the contact information of the collaborator in charge of managing the alert 260, for example of the furniture worldwide sales manager,
the cause(s) of the alert, for example “Above Tolerance Range Upper Limit 230”,
the names and contact information of the other users concerned by this alert, for example the France and Germany sales managers 113, 114,
a time range of the conflict, for example the furniture sales of in France and in Germany during the months M3 to M5, and
support tools for conflict management, for example a consensus button (not shown) for accessing a consensus display 203 as described in detail below, the latter including conflict sub-alert indicators 260, each of these relating for instance to an individual data element of a sub-forecast.

### b) Collaborative Consensus Engine and Display

The one or several conflict alert indicators 260 are associated with a consensus button 266. Upon activation of this consensus button 266 (preferably only by user 112), the edition module 143 generates a collaborative consensus display 203 common to all users (in this case 112, 113, 114) concerned with this conflict alert 260, this display being shown in the top portion of FIG. 2B.

The collaborative consensus display 203 comprises a representation in the form of graphs and tables of the original forecasts 221, 222 and of the collaborative forecasts 250, 251, 252 as well as of the tolerance range limits 230, 240.

Using button 261, user 112 can modify the tolerance range limits 230, 240. Buttons 262 and 263 enable user 112 to respectively lock the collaborative sub-forecasts 251 and 252. Button 264 allows user 112 to reject all the collaborative sub-forecasts 251 and 252.

Depending on his rights in the initialization set 1422, each user 112, 113, 114 may modify or lock a part of the corresponding data. Thus, the sales manager 112 responsible for the worldwide furniture sales may modify the tolerance range limits 230, 240 after having activated button 261. The France and Germany furniture sales managers 113 and 114 may modify any data of their respective collaborative sub-forecasts 251 and 252.

The collaborative forecast 250 that consolidates the collaborative sub-forecasts 251 and 252 is re-computed and updated after each change made by edition module 143, the alert indications 260 being also updated. When user 112 activates button 262 (respectively 263), this has the effect of locking (or freezing) the collaborative sub-forecast value 251 (respectively 252), i.e. the corresponding data may not be modified any longer by any user such as 113, 114. A pictogram representing a closed padlock 276 indicates the locking of these data. As a consequence of the locking, a modification made at an upper level in the tree-structure will propagate only to the sub-forecasts which are not locked. Thus for instance, if the collaborative sub-forecast in France 251 is locked, any modification of the collaborative worldwide forecast 250 will only affect the collaborative forecast in Germany 252.

According to an extension of this embodiment of the present disclosure, additional locking buttons such as 2621, 2622 and 2631, 2632 enable to individually block any data element of these sub-forecasts 251, 252. In such case, the activation of button 262 (respectively 263) causes that of the buttons 2621, 2622 (respectively 2631, 2632) corresponding to the sub-forecasts in the tree structure.

According to a second extension of this embodiment of the present disclosure, two users 113, 114 can make two collaborative sub-forecasts 251, 252 over the same perimeter such as furniture sales in France. When these two collaborative sub-forecasts 251, 252 do not coincide, the activation of a convergence button 265 opens a menu that enables user 112 (higher in the hierarchy) to set a single collaborative sub-forecast. This menu can trigger pre-established computing tools allowing selection of, for each time period, the data of one or the other collaborative sub-forecast 251, 252, or the lower data among both data, or the higher data among both, or the average of these data, or other values that he can set at his convenience.

Furthermore, the quantitative distribution of the conflict perimeter, user by user, is shown as a pie chart 267. Each sector thereof represents the part of the conflict attributable to a given user 113, 114.

Rules for determining the sizes of the sectors are for instance as follows, for the case where the conflict is caused by exceeding an upper tolerance range limit 230, the surface of each sector is computed as follows:

Sector 2671=(original sub-forecast (user 114, month i)+collaborative sub-forecast (user 113, month i)−upper tolerance corridor (month i))

Sector 2672=(original sub-forecast (user 113, month i)+collaborative sub-forecast (user 114, month i)−upper tolerance corridor (month i))

Sector 2673=2×(upper tolerance corridor (month i)−original sub-forecast (user 113, month i)−original sub-forecast (user 114, month i))

where “i” designates each month of the conflict period.

In the example shown, sector 2671 has a size of 8/115, i.e. 7%, sector 2672 has a size of 19/115, i.e. 16.5%, and sector 2673 has a size of 88/115, i.e. 76.5%.

The skilled person will be able to design computations adapted to other types of conflicts.

Finally, by activating button 268, the user can close the window of the collaborative consensus display 203 and suspend the collaborative consensus. This action preferably takes place when all the conflicts have been solved and conflict alert indications 260 have been switched off, i.e. when the collaborative consensus is completed. The window can also be closed automatically after all conflicts have been solved.

### c) Tolerance Segment, Targets and Uncertainties

In a more elaborate embodiment of the present disclosure, user 112 has other tools to manage original forecast 220 in addition to the tool for managing the tolerance range 230, 240.

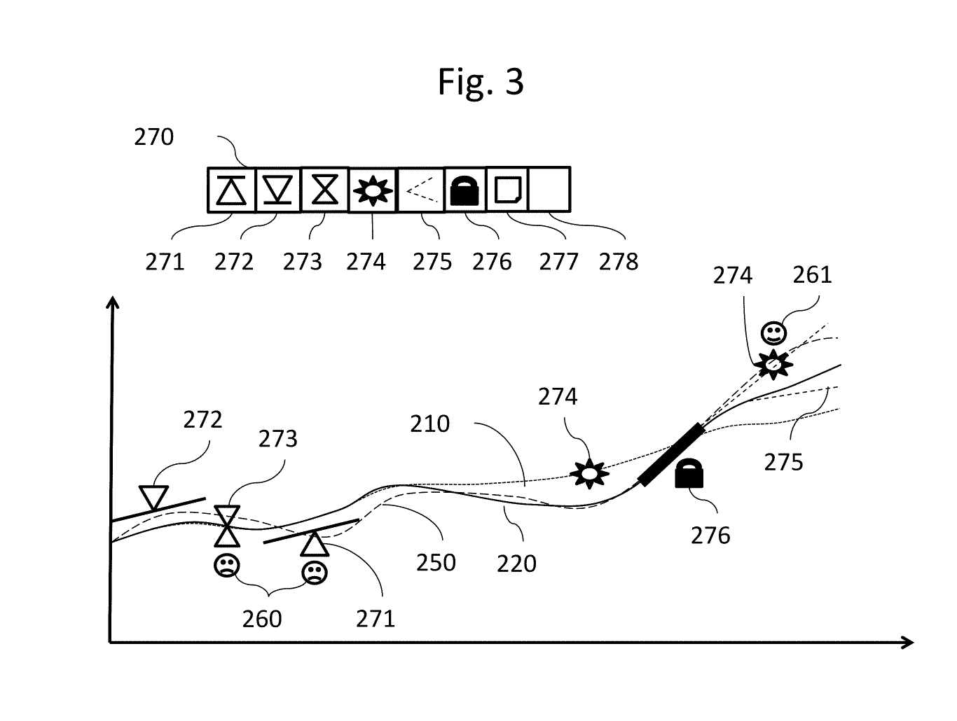

Referring to FIG. 3, a set of pictograms 270 generated by the edition module 143 enable the user 112 to access advanced functions 271 to 277.

Preferably using a drag-and-drop technique, two of these pictograms, 271, 272, allow positioning low and high tolerance segments that can be defined over certain time periods.

Another pictogram 273 allows setting particular data element at a given time to a constant value.

These constraints 271, 272, 273 are handled by the collaborative consensus tool in the same manner as the tolerance range 230, 240 described above. In this case, when a collaborative forecast 250 breaks a tolerance segment 271, 272 or is different from a constant value 273, a conflict alert is generated and indicated at 260.

Another pictogram 274 enables user 112 to set target values. Corresponding sub-targets are computed on the basis of these targets 274 according to the following pro rata rule:

sub-target=(target×original sub-forecast)/original forecast

These targets and sub-targets are results that should ideally be achieved during the collaborative consensus (steps 460 to 490 described in the following). When the collaborative forecast 250 exceeds a target 274, a bonus is generated. This bonus is computed by the edition module 143 in a similar manner as an alert 260.

Another pictogram 275 enables user 112 to define an uncertainty corridor or range, on the basis of which uncertainty sub-ranges can be computed according to an above mentioned pro rata rule. Such uncertainty range enables user 112 to indicate to collaborators under his hierarchy (users 113, 114 in this example) his lack of visibility over the forecasts, without having to impose the constraints of a tolerance segment 271, 272. This makes possible in practice to initiate a discussion between collaborators 112, 113, 114 during a collaborative consensus.

A locking pictogram 276 enables the user 112 to lock a set of data of the collaborative forecast 250. This locking freezes the sum of the data of the sub-forecasts 251, 252 over the corresponding period. Depending on how this locking is parameterized by user 112 or by a supra-user, either the change in a sub-forecast 251 conversely affects the sub-forecast 252, or the sub-forecasts 251, 252 are compressed or expanded according to an above mentioned pro rata rule.

Another pictogram 277 allows accessing a menu for parameterization of display filters used for displaying the forecast. User 112 may thus define the information that will appear in the collaborative consensus displays, among which: the graph representation 201, the tabular representation 202, the constraints 230, 240, 271, 272, 273, the targets 274, the uncertainties 275, the alerts 260, the bonuses 262 and the padlocks 276. Other advanced functions accessible by button 278 may allow user 112 to add comments, to access the history of modifications, to compare two intermediate versions of a forecast, to track the modifications made by each user, etc.

### d) Management of Multiple Sub-Forecasts

A practical embodiment of the system according to the present disclosure allows handling more than two sub-forecasts per level of the tree structure.

For the purpose of the explanation according to the present disclosure, it has been considered hitherto that the consolidation according to an aggregation method of collaborative sub-forecasts 251 and 252 by users 113, 114, according to the initialization set, constitutes the collaborative forecast 250 of user 112. However, in a practical situation, the number of branches linked to a node of a tree structure is of course not limited to two. Thus, the collaborative forecast 250 by a worldwide furniture sales manager will in most cases be the result of the aggregation of the P collaborative sub-forecasts of the sales managers in charge of different countries or regions.

The system 100 is then designed to handle these P sub-forecasts. In practice, table 202 comprises P lines for the sub-forecasts; display 203 can show up to P sub-forecasts in addition to the corresponding main forecasts, the filtering allowed by button 277 enabling to adjust the display contents for readability purposes. Similarly, display 203 may comprises P buttons 262, 263, . . . that enable user 112 to lock P collaborative sub-forecasts 251, 252, . . . .

### e) Handling of Multiple Axes

Again in a practical embodiment of the present disclosure, the system enables users to handle conflicts between axes.

For the purpose of the explanation according to the present disclosure, only one axis has been considered hitherto, i.e. a geographical axis (world, France, Germany). In a practical embodiment of the present disclosure, the initialization set 1422 contains as many tree structures as there are axes or dimensions in the data structure (by geography, by product, by distributor, etc.).

In this practical example, two tree structures represent two axes, e.g. a geographical axis (e.g. world, France, Germany) and a product axis (e.g. furniture, chairs, desks).

Thus, the initial forecast 210 consolidates two initial sub-forecasts according to the geographical axis and two initial sub-forecasts according to the product axis; similarly, the original forecast 220 consolidates two original sub-forecasts (221, 220 in the above example) according to the geographical axis and two original sub-forecasts according to the product axis. The table 202 comprises in such case two additional lines corresponding to the additional original sub-forecasts along the product axis; these original sub-forecasts, four in total is this case, can be respectively modified by the sales manager for furniture in France (113), the sales manager for furniture in Germany (114), the sales manager for chairs worldwide (user 115) and the sales manager for desks worldwide (user 116), so as to form four collaborative sub-forecasts (251, 252 as shown in FIG. 2B plus two other, 253 and 254 as shown in the table below, along the product axis); the consolidation thereof axis by axis results in two collaborative forecasts 250 at the level of the worldwide furniture (user 112); conflict alerts indicated at 260 are generated by the edition module 143 when:
(i) the tolerance range 230, 240 is broken by one of the two collaborative forecasts 250,
(ii) there is a divergence between two collaborative forecasts 250, or
(iii) there is a divergence between components, as described in detail here below.

After having activated the collaborative consensus button, user 112 can, access a menu allowing him to invite to a collaborative consensus session the users (under his hierarchy) that he wishes to have in the session, and in this example either all four users 113, 114, 115, 116 who have generated the sub-forecasts along the two axes, or only those along a particular axis (here by geography or by product).

In case only the geographical managers (users 113, 114) do participate in the collaborative consensus (as described in the following at steps 460 to 490), the change of a particular data element of the collaborative sub-forecast for France 251 results in the modification by default of two product data (chairs France and desks France) that do constitute this particular data element, according to an above mentioned pro rata rule. As a variant, the sales manager responsible for the sales of furniture in France 113 can modify a first product data element, the second product data element being computed by difference of this particular data element and of this first product data element. The same applies to the collaborative sub-forecast for Germany 252.

The same computation of these two geographical data (chairs France and chairs Germany) is performed in case only the managers responsible for the product axis 115, 116 do participate in the collaborative consensus.

In case all four users (in this example) participate in the collaborative consensus session, in order to resolve the conflicts, user 112 has access to a set of buttons for performing the following actions:
for a particular month i, the following data of the collaborative sub-forecasts 251 to 254 are defined according to the following table:

| User | 115 (Chairs) | 116 (Desks) | |
|---|---|---|---|
| 113 (France) | A1, A2 | B1, B2 | SPC(251, i) |
| 114 (Germany) | C1, C2 | D1, D2 | SPC(252, i) |
| | SPC(253, i) | SPC(254, i) | PC(250, i, 1), PC(250, i, 2) |

in which SPC (251,i) is the data element of the collaborative sub-forecast 251 by user 113 for the month i, and is the sum of the two components A1 and B1 that represent the sales forecasts for chairs and desks in sub-forecast 251 for sales of furniture in France. The other SPC values are determined in a corresponding manner.

The relationships are as follows:

A1+B1=SPC(251,i)

C1+D1=SPC(252,i)

A2+C2=SPC(253,i)

B2+D2=SPC(254,i)

PC(250,i,1)=SPC(251,i)+SPC(252,i)

PC(250,i,2)=SPC(253,i)+SPC(254,i)

The value of the component A1 is computed by the edition module 143 by applying the pro rata rule defined above: it is first initialized thanks to the corresponding initial value contained in the initialization set according to the geographical axis. It is then recomputed as a pro rata value when computing the original sub-forecast 221. At this stage, the twin components are always identical, i.e. A1=A2, B1=B2, C1=C2 and D1=D2.

The twin components A1 and A2 are liable to diverge when users 113 and 115 determine their collaborative sub-forecasts 251 and 253. The same applies for the other twin components.

As indicated above, a divergence conflict alert indication 260 is generated when two collaborative forecasts 250 do not coincide, i.e. when PC(250,i,1) is different from PC(250,i,2).

In order to remove this alert 260, user 112 can use the convergence button 265 to set a single value PC(250,i) as described above. The component values for this single are then recomputed by applying the above mentioned pro rata rule.

Similarly, the convergence button 265 enables the user to set a single value to solve the divergence conflicts between twin components.

Finally, user 112 can use the locking buttons 2621, 2622 (see FIG. 2B) to individually freeze certain data such as the components. He can also use locking buttons 262, 263 to freeze a set of data or a sum such as PC(250,i) and SPC(251,i). Advantageously, a parameterization of the locking actions is available.

The other buttons 261, 264 are also available for a step by step removal of all conflict alerts indicated at 260.

Control panels may be provided for aiding user 112 is making his data locking decisions. This panels comprise e.g. a conflict allocation tool such as a pie chart 267 or tools for visually illustrating deviations, such as using a specific color for curve segments representing SPC(251,i) and SPC(253,i) when a certain relationship between components exist, for instance when a relationship such as 0.9<A1/A2<1.1 is met. User 112 can also delegate his rights, for example authorize the sales manager for France to set himself the values of the forecasts “chairs France” and “desks France” or their ratio, for example 60%/40%.

### f) Process

### (i) Basic Embodiment

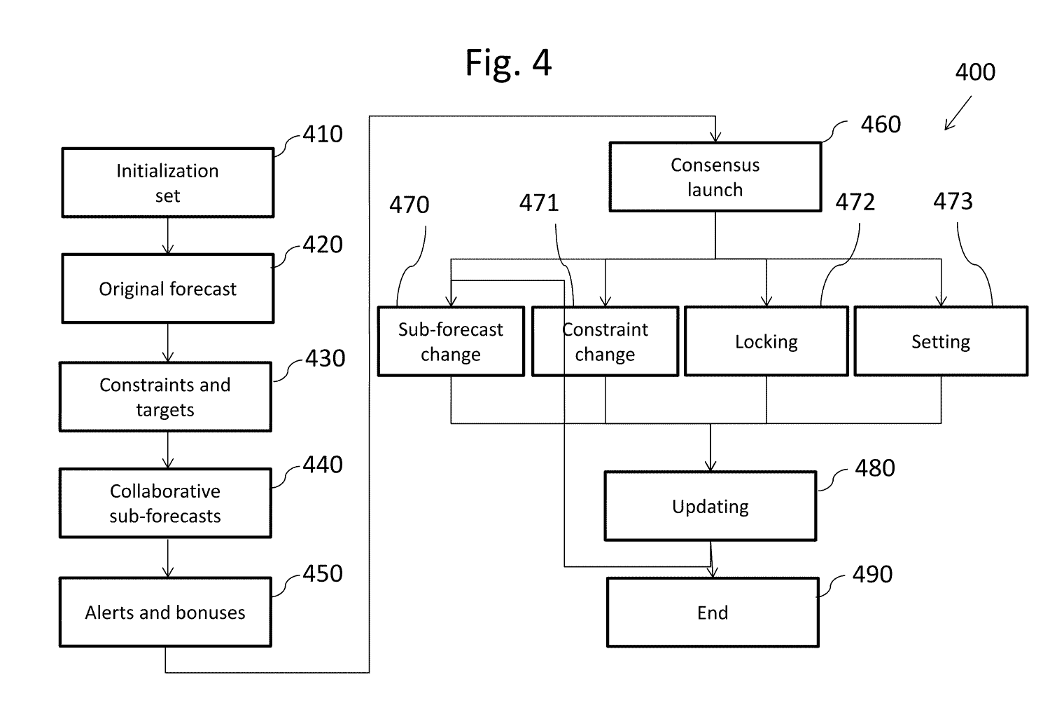

Referring to FIG. 4, a collaborative process 400 according to the present disclosure comprises the following steps.

In step 410, the initialization module 142 generates and stores an initialization set 1422 containing in particular the initial forecasts and sub-forecasts such as 210, 211, 212.

In step 420, user 112 modifies the initial forecast 210 with the edition module 143 to develop an original forecast 220. The edition module 143 computes the original sub-forecasts 221, 222 forming said forecast 220.

In step 430, user 112 associates the original forecast 220 with constraints 230, 240, 271, 272, 273.

In step 440, user 113 modifies the original sub-forecast 221, leading collaborative sub-forecast 251. User 114 modifies the original sub-forecast 222, leading to collaborative sub-forecast 252.

In step 450, the edition module 143 computes the collaborative forecast 250 by applying an aggregation method contained in the initialization set 1422, and detects conflicts between the collaborative forecast 250 and constraints 230, 240, 272, 272, 273 and then generates the corresponding alerts 260.

The following steps describe the part of the process of performing the collaborative consensus.

In step 460, upon activation of consensus button by user 112, the edition module 143 generates a collaborative consensus display 203 that is common to the users 112, 113, 113 involved in the conflict underlying alert 260.

In step 470, a user 113 or 114 modifies his collaborative sub-forecast 251, 252.

In step 471, user 112 modifies a constraint 230, 240, 271, 272, 273.

In step 472, user 112 locks a collaborative sub-forecast (e.g. 251, 252) with a locking button (e.g. 262, 263), or a data element of this sub-forecast with a locking button (e.g. 2621, 2622).

In step 473, user 112 sets a single set of values for two divergent collaborative sub-forecasts 251, 252, using the convergence button 265.

In step 480, the edition module 143 updates the collaborative forecast 250, the conflict detection and generation of alerts 260, and the collaborative consensus display 203.

Steps 470, 471, 472 and 473 are carried out in parallel. As long as the user 112 does not activate the “Close” button 268 after step 480, this step loops back to the preceding steps 470, 471, 472, 473.

In step 490, user 112 completes the collaborative consensus process by activating the button 268, preferably after having ascertained that all the conflict alerts 260 have all been removed.

### (ii) Management of Targets and Bonuses

In a more elaborate embodiment of the present disclosure, the process 400 enables to define targets as a complement to the constraints, as follows.

In step 430, the user also sets targets 274.

In step 450, the edition module 143 also computes the bonuses 261, depending on the overshooting of the targets 274 by the collaborative forecast 250.

In step 471, the user 112 can also modify the targets 274.

In step 480, the edition module 143 also updates the bonuses 261.

(iii) Management of Multiple Sub-Forecasts

In a still more elaborate embodiment of the present disclosure, the process 400 allows to handle more than two sub-forecasts per tree structure level.

Thus, in step 410, the initialization module 142 develops P initial sub-forecasts 211, 212, . . . for each initial forecast 210.

In step 420, the edition module 143 computes P original sub-forecasts 221, 222, . . . .

In step 440, one or several of the P users modify their respective P original sub-forecasts 221, 222, . . . to generate P collaborative sub-forecasts 251, 252, . . . .

In step 460, the edition module 143 generates the collaborative consensus display 203, common to the P users, this display containing all or part of the P collaborative sub-forecasts 251, 252, . . . , depending on the adjustments of filter 277.

In step 470, one among the P users changes his collaborative sub-forecast 251, 252.

(iv) Management of Conflicts between Axes

In a still more refined embodiment of the present disclosure, the process 400 allows the handling of a plurality of tree structures corresponding to a plurality of axes.

Thus, in step 410, the initialization module 142 generates initial sub-forecasts such as 211, 212 along a plurality of axes.

In step 420, edition module 143 computes the components of the data of the original sub-forecasts according to the different axes.

In step 440, each of the several users such as 113, 114, 115, 116 generates his collaborative sub-forecast such as 251 to 254 and the edition module 143 updates the components of these collaborative sub-forecasts 251 to 254 by applying the pro rata rule.

In step 450, edition module 143 computes the collaborative forecasts 250 according to each axis, detects the conflicts and generates the corresponding alert indications 260 relating to divergences between components or between collaborative forecasts 250.

In step 460, user 112 additionally chooses to launch a collaborative consensus session with all the users who are the forecasters of the collaborative sub-forecasts such as 251 to 254 or only with a limited number of users according to a particular axis (e.g. geographical or by product).

In step 472, user 112 can also lock a forecast component, a set of forecast components or a sum with a locking button such as 2621, 2622, after having possibly adjusted the locking parameters.

In step 473, user 112 can also set a single set of values for two series of divergent values such as divergent collaborative forecasts 250 or divergent data or divergent components.

### (v) Extensions

For the purpose of the present description, the present disclosure has been described with a limited number of users, of axes and of sub-forecasts per level of a tree-structure. In a practical case, an initialization set 1422 will most often contain the combination of several axes and of a variable number of sub-forecasts according to the axes and to the tree-structure levels. Similarly, the number of users can be very large; the rights of a given user can extend on variable perimeters at different levels, as defined by user rights parameterization.

The generation of forecasts, sub-forecasts and components can take place at any level of a tree structure. For instance, a sub-forecast at a particular level can be the main forecast as seen from a lower level in the tree-structure. Similarly, the collaborative sub-forecast at a certain level is the original forecast at a lower level, etc.

The original and collaborative forecasts can be generated, and the related conflicts managed, at different levels successively, alternately or simultaneously.

In order to initiate a collaborative consensus (460 to 490), the activation of the consensus button can cause the opening of a collaborative consensus session by sending a notice to each user e.g. 112, 113, 114 concerned by the alert 260, for instance by email from an online organizer. A consensus session is held then held, using display 203 but also videophone and other known collaborative tools.

In step 490, a user having the proper rights such as user 112 in the above description can interrupt the collaborative consensus process even if all the alerts 260 have not been removed, in particular if this consensus process needs to be temporarily interrupted while waiting for the outcome of discussions with third parties or other users.

Of course, the present disclosure is not limited to the above description, but the skilled person will be able, from his general knowledge, to devise many other embodiments and variants, within the scope of the appended claims.

1. A computerized system comprising:
a set of client terminals for respective users,
an enterprise resource planning server accessible by said client terminals and storing business data, including business historical data,
a collaboration server in communications with said enterprise resource planning server and also accessible by said client terminals,
means for receiving from a plurality of client terminals controlled by a plurality of hierarchically-organized users and for storing a plurality of forecast data values including main forecast values and sub-forecast values and elementary data values as subdivisions of said forecast values and said sub-forecast values,
means for setting rules relating to said values, said rules including aggregation rules for said values and alert thresholds for said values,
means for detecting lack of compliance between said values and said rules, and
a collaborative consensus engine for launching a collaborative consensus session accessible by client terminals corresponding to at least a group of users having provided values involved in the lack of compliance, said engine being adapted for selectively displaying alert indications in response to said detection means, values involved in said lack of compliance, for changing values in response to actions by users entitled to make value changes so as to remove lack of compliance, for computing other values in response to the change of values, for setting and changing rules in response to actions by users entitled to make rule changes, and for causing said detection means to detect again lacks of compliance after changes performed through said collaborative consensus engine.

2. The system according to claim 1, further comprising means for generating an initialization set for said values, said initialization set comprising initial values determined from historical data, access and modification rights for each user for said values, hierarchical data structures for said values, and said aggregation rules.

3. The system according to claim 2, further comprising means for generating original values from said initial values in response to inputs by users entitled to change said values.

4. The system according to claim 2, wherein said means for setting rules comprise user interface means for setting a lower limit value or an upper limit value or a tolerance range for a forecast value, and said detection means comprise means for detecting when a sub-forecast value belonging to an aggregation leading to said forecast value has caused a breaking of the limit value or range.

5. The system according to claim 2, wherein said means for setting rules comprise user interface means for freezing a forecast value, and said detection means comprise means for detecting when a sub-forecast value belonging to an aggregation leading to said forecast value has caused a violation of the frozen value.

6. The system according to claim 2, wherein said means for setting rules comprise user interface means for freezing a forecast value, and the collaborative consensus engine is capable of computing values of sub-forecast values aggregated into said forecast value based on the frozen value.

7. The system according to claim 1, wherein said collaborative consensus engine comprises means for displaying the relative weights of value changes in a given lack of compliance.

8. The system according to claim 2, wherein said hierarchical data structures comprise data tree-structures along at least two axes, and said collaborative consensus engine comprises means for forcing an aggregated forecast value along one axis to equal an aggregated forecast value along another axis and for re-computing sub-forecast values along said two axes in accordance with said forcing.

9. A computed-implemented collaborative forecasting method implemented in a computerized environment including a set of client terminals for respective users, an enterprise resource planning server accessible by said client terminals and storing business data, including business historical data, and a collaboration server in communications with said enterprise resource planning server and also accessible by said client terminals, said method comprising the following steps:
receiving at said collaboration server from a plurality of client terminals controlled by a plurality of hierarchically-organized users a plurality of forecast data values including main forecast values and sub-forecast values and elementary data values as subdivisions of said forecast values and said sub-forecast values, and storing said values,
detecting lack of compliance between said values and predefined rules relating to said values, said rules including aggregation rules for said values and alert thresholds for said values,
in a collaborative consensus user interface, selectively displaying values involved in said lack of compliance, performing at least one of the following consensus-reaching steps:
changing values in response to actions by users entitled to make value changes so as to remove lack of compliance,
in response to a value change, re-computing values linked to said changed value through aggregation rules,
setting and changing rules in response to actions by users entitled to make rule changes, and
detecting again said a lack of compliance after at least one consensus-reaching step has been performed.

10. The method according to claim 9, further comprising a step of generating an initialization set for said values, said initialization set comprising initial values determined from historical data, access and modification rights for each user for said values, hierarchical data structures for said values, and said aggregation rules.

11. The method according to claim 9, further comprising a step of generating original values from said initial values in response to inputs by users entitled to change said values.

12. The method according to claim 10, wherein said step of setting rules comprises setting a lower limit value or an upper limit value or a tolerance range for a forecast value, and said detection step comprises detecting when a sub-forecast value belonging to an aggregation leading to said forecast value has caused a breaking of the limit value or range.

13. The method according to claim 10, wherein said step of setting rules comprises freezing a forecast value, and said detection step comprises detecting when a sub-forecast value belonging to an aggregation leading to said forecast value has caused a violation of the frozen value.

14. The method according to claim 10, wherein said step of setting rules comprises freezing a forecast value, and further comprising a step of computing values of sub-forecast values aggregated into said forecast value based on the frozen value.

15. The method according to claim 9, further comprising a step of displaying the relative weights of value changes in a given lack of compliance.

16. The method according to claim 10, wherein said hierarchical data structures comprise data tree-structures along at least two axes, and further comprising a step of forcing an aggregated forecast value along one axis to equal an aggregated forecast value along another axis and a step of re-computing sub-forecast values along said two axes in accordance with said forcing.
